(19) United States
(12) Patent Application Publication
(10) Pub. No.: US 2017/0104593 A1
(43) Pub. Date: Apr. 13, 2017

(54) KEY STORAGE METHODS

(71) Applicant: Safe Cash Payment Technologies, Inc., Incline Village, NV (US)

(72) Inventors: Vinh H. Vo, San Jose, CA (US); Hung Q. Ta, Hanoi (VN)

(21) Appl. No.: 15/290,562

(22) Filed: Oct. 11, 2016

Related U.S. Application Data
(60) Provisional application No. 62/240,072, filed on Oct. 12, 2015.

(51) Int. Cl. H04L 9/08; G06K 19/06; G06K 7/14

(52) U.S. Cl. CPC H04L 9/0822; G06K 7/1417; G06K 19/06037

(57) ABSTRACT

A method of storing a security key used for encrypting and decrypting data is provided. A host Quick Response (QR) code host image QR_{O} is generated and a security key used with encryption/decryption of data is divided. Portions of the security key are sequentially embedded into QR codes to generate a final QR code host image QR_{N} with a second security key. The final QR code host image QR_{N} and the second security key are stored and then the final QR code host image QR_{N} is decrypted in reverse order of sequentially embedding the divided security key to generate the host QR code host image QR_{O} to obtain the first security key.

### RELATED APPLICATIONS

This application claims the benefit of provisional patent application Ser. No. 62/240,072, filed Oct. 12, 2015, the disclosure of which is hereby incorporated herein by reference in its entirety.

### FIELD OF THE DISCLOSURE

Embodiments of the present disclosure relate generally to secure storage of data and more specifically to the secure storage of security keys used in conjunction with encryption algorithms.

### BACKGROUND

In today's computing environments, many users transmit data over unsecure communication paths, such as the Internet. However, the possibility exists that an unauthorized third party may access the data during transmission. In order to protect the data that is being transmitted, users typically encrypt the data such that if an unauthorized third party intercepts the data, the unauthorized third party will not be able to access the data. Typically, the data is encrypted with an encryption algorithm used in conjunction with a security key. In many instances, the security key is limited to a certain byte and character length, such as 256 bits. In order to gain access to the encrypted data, an unauthorized user must have both the encryption algorithm used to encrypt the data and the security key used in conjunction with the encryption algorithm during encryption of the data. Often times, the encryption algorithm is well-known and the unauthorized third party only needs to determine the security key that was used during data encryption. In some instances an authorized user may simply steal the security key and decrypt the encrypted data with the stolen security key.

Therefore, what is needed is a method for securely storing a security key in which the possibility of an unauthorized user obtaining the security key is minimized.

### SUMMARY

Embodiments of the present disclosure relate to storing a security key used for encrypting and decrypting data. Embodiments of the present invention include five steps, generating a host Quick Response (QR) code host image QR_{O}, dividing a first security key used with encryption/decryption of data, sequentially embedding portions of the divided security key into QR codes to generate a final QR code host image QR_{N} with a second security key, storing the final QR code host image QR_{N} and the second security key, and decrypting the final QR code host image QR_{N} with the second security key in the reverse order of sequentially embedding the divided security key to generate the host QR code host image QR_{O} to obtain the first security key.

In one embodiment, a fake security key is used to generate the host QR code host image QR_{O}. In an embodiment, a first security key, which is used to encrypt data, is divided into a number (N) of portions. The N portions of the first security key are considered N watermarks that will sequentially be embedded into the host QR code host image QR_{O}. Here, the host QR code host image QR_{O} will function as a host image for subsequent watermarking steps of the N portions of the first security key. For example, a first portion of the first security key is encrypted with a second security key separate from the first security key to create a first watermark. The first watermark is embedded into the host QR code host image QR_{O} to generate a first QR code host image QR₁. In an embodiment, a second portion of the first security key is encrypted with the second security key to create a second watermark. The second watermark is embedded into the first QR code host image QR₁ to generate a second QR code host image QR₂. A third portion of the first security key is encrypted with the second security key to create a third watermark. The third watermark is embedded into the second QR code host image QR₂ to generate a third QR code host image QR₃. This process is repeated N number of times to generate the final QR code host image QR_{N}.

In an embodiment, after generation of the final QR code host image QR_{N}, the second security key and a map used to reconstruct the first security key from the N portions stored in the final QR code host image QR_{N} are encoded into a QR code QRₖ. Once the QR code QRₖ is generated, both the final QR code host image QR_{N} and the QR code QRₖ are stored in separate locations.

In an embodiment, in order to obtain the first security key, the final QR code host image QR_{N} must be decoded in reverse order from that used to embed the N number of watermarks into the final QR code host image QR_{N}. Initially, the final QR code host image QR_{N} and the QR code QRₖ are obtained from their separate locations. A standard decoder is then used to obtain the fake security key and a standard encoder is used to build the host image OR_{O}. A standard QR decoder is also used to obtain the second security key and the map from the QR code QRₖ. Once the second security key is obtained, the final QR code host image QR_{N} is used as an input and the second security key and the map are used to decrypt the final QR code QR_{N} in order to obtain the QR codes QR₁ through QR_{N}. The QR codes QR₁ through QR_{N} are decrypted in the reverse order in which they were encrypted. Thus, in the instance when the first security key is divided into three portions, the third QR code host image QR₃ is decrypted first, followed by the second QR code host image QR₂, and then finally by the first QR code host image QR₁. The decrypted portions of the first security key are then reassembled using the map to obtain the first security key.

In a second embodiment of the present disclosure, a watermark host color image may be used to store the first security key instead of a host QR code. In the second embodiment, there are five steps. Here, a host image is a color image and a first security key used with encryption/decryption of data is divided into a number (N) of portions, portions of the divided security key are sequentially embedded into the watermark host color image to generate a final watermark host color image IMG_{W} with a second security key, the final watermark host color image IMG_{W} and the second security key are stored, and the final watermark host color image IMG_{W} with the second security key are decrypted in the reverse order of sequentially embedding the divided security key to generate the watermark color host image to obtain first security key.

In the second embodiment, a watermark host color image IMG_{O} is used as a host color image. Here, a first security key, which is used to encrypt data, is divided into a number (N) of portions. The N portions of the first security key are considered N watermarks that will sequentially be embedded into the watermark host color image NG& The watermark host color image IMG_{O} will function as a host image for subsequent watermarking steps of the N portions of the first security key where the N portions of the first security key will be sequentially watermarked into the watermark host color image IMG_{O} to create a final watermark host color image IMG_{W}. For example, a first portion of the first security key is encrypted with a second security key separate from the first security key to create a first watermark. The first watermark is embedded into the watermark host color image IMG_{O} to create a first watermark host color image IMG₁. In an embodiment, a second portion of the first security key is encrypted with the second security key to create a second watermark. The second watermark is embedded into the first watermark host color image IMG₁ to generate a second watermark host color image IMG₂. A third portion of the first security key is encrypted with the second security key to create a third watermark. The third watermark is embedded into the second watermark host color image IMG₂ to generate a third watermark host color image IMG₃. This process is repeated N number of times to generate the final watermark host color image IMG_{W}.

In an embodiment, after generation of the final watermark host color image IMG_{W}, the second security key and a map used to reconstruct the first security key from the N portions stored in the final watermark host color image IMG_{W} are encoded into a QR code QRₖ. Once the QR code QRₖ is generated, both the final watermark host color image IMG_{W} and the QR code QRₖ are stored in separate locations.

In an embodiment, in order to obtain the first security key, the final watermark host color image IMG_{W} is decoded in reverse order from that used to embed the N number of watermarks into the final watermark host color image IMG_{W}. Initially, the final watermark host color image IMG_{W} and the QR code QRₖ are obtained from their separate locations. A standard decoder is then used to obtain the fake security key and a standard encoder is used to build the final watermark host color image IMG_{W}. A standard QR decoder is also used to obtain the second security key and the map from the QR code QRₖ. Once the second security key is obtained, the final watermarking image IMG_{W} is used as an input and the second security key and the map are used to decrypt the portions of the first security key embedded in the final watermarking image IMG_{W}. The watermarks embedded in final watermarking image IMG_{W} are decrypted in the reverse order in which they were encrypted and embedded into the final watermarking image IMG_{W}. Thus, in the instance when the first security key is divided into three portions, the third portion of the first security key is decrypted first, followed by the second portion of the first security key, and then finally by the first portion of the first security key. The decrypted portions of the first security key are then reassembled using the map to obtain the first security key.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a cloud based operating system having devices that are part of the cloud based operating system in accordance with an embodiment of the present disclosure.

FIG. 2A illustrates the method for security key storage in accordance with an embodiment of the present disclosure.

FIG. 2B illustrates the method for security key storage in accordance with an embodiment of the present disclosure.

FIG. 3 is an embodiment of illustrating a method of accessing a first security key stored using the method described with reference to FIGS. 2A and 2B.

FIG. 4A illustrates a method of embedding a first security key into a host color image, in accordance with an embodiment of the present disclosure.

FIG. 4B illustrates a method of embedding a first security key into a host color image, in accordance with an embodiment of the present disclosure.

FIG. 5 is an embodiment of the present disclosure illustrating a method of accessing a first security key stored using the method described with reference to FIGS. 4A and 4B.

FIG. 6 is a block diagram of a device according to one embodiment of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Embodiments of the present disclosure relate to storing a security key used for encrypting and decrypting data. Embodiments of the present invention include five steps, generating a host Quick Response (QR) code host image QRo, dividing a first security key used with encryption/decryption of data, sequentially embedding portions of the divided security key into QR codes to generate a final QR code host image QR_{N} with a second security key, storing the final QR code host image QR_{N} and the second security key, and decrypting the final QR code host image QR_{N} with the second security key in the reverse order of sequentially embedding the divided security key to generate the host QR code host image QR_{O} to obtain first security key.

In a second embodiment of the present disclosure, a watermark host color image may be used to store the first security key instead of a host QR code. In the second embodiment, there are five steps. Here, a watermark color host image is generated, a first security key used with encryption/decryption of data is divided into a number (N) of portions, portions of the divided security key are sequentially embedded into the watermark host color image to generate a final watermark host color image IMG_{W} with a second security key, the final watermark host color image IMG_{W} and the second security key are stored, and the final watermark host color image IMG_{W} with the second security key are decrypted in the reverse order of sequentially embedding the divided security key to generate the watermark color host image to obtain first security key.

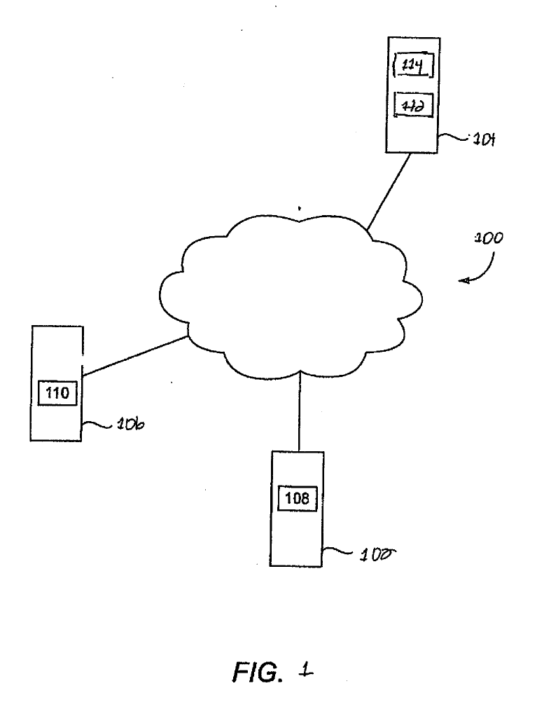

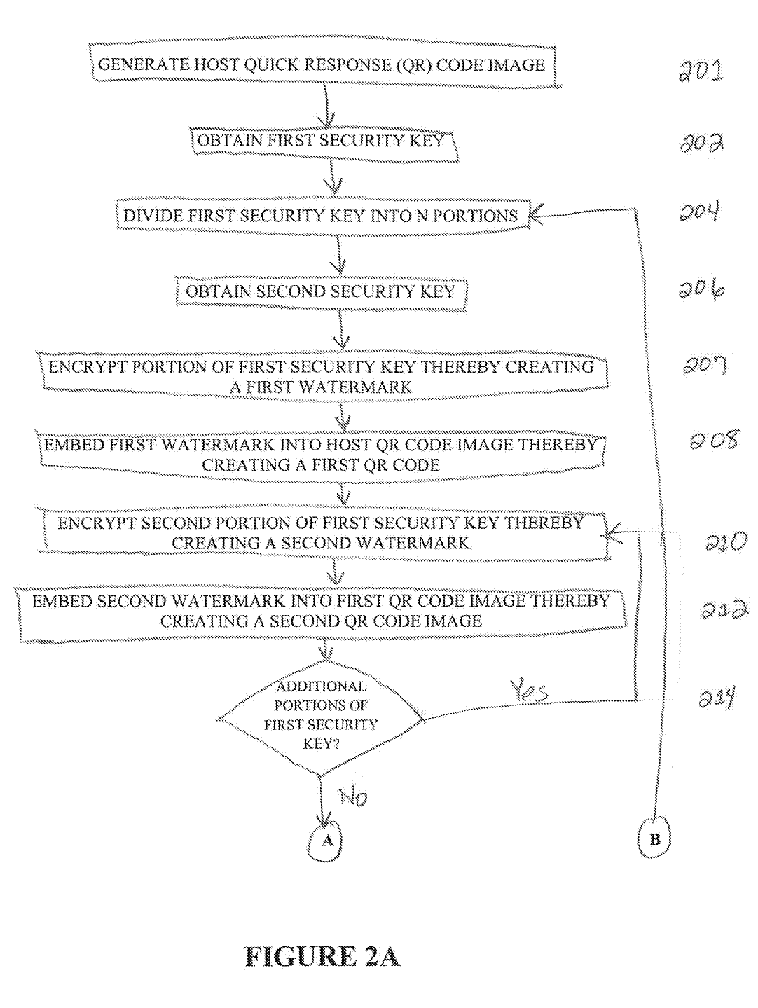

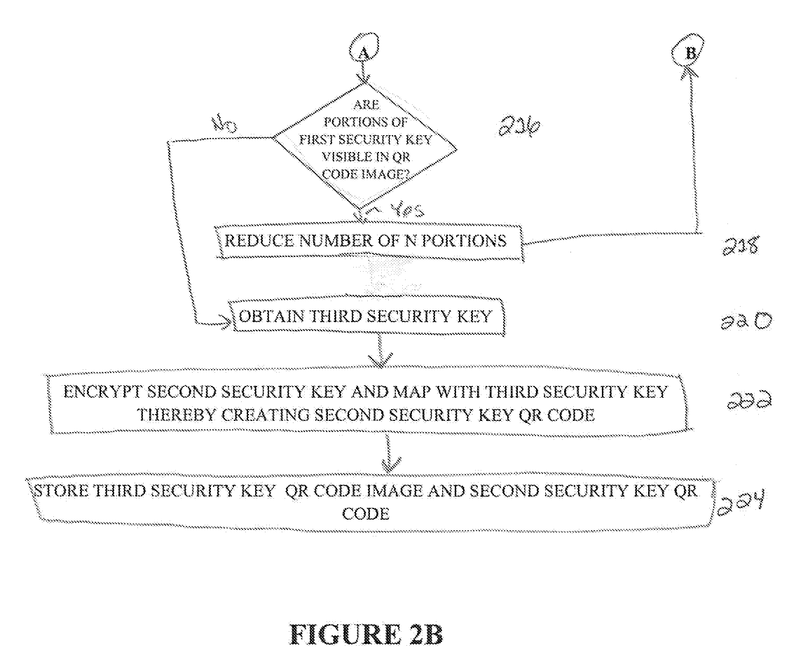

An example of an environment where embodiments of the present disclosure may be practiced is in FIG. 1. FIG. 1 illustrates a cloud based operating system 100 having devices 102-106 that are part of the cloud based operating system 100. In one embodiment of the present disclosure, the devices 102-106 may be any type of device, such as a computing device, including a work station, a desktop or laptop computer, or a tablet computer. In addition, each of the devices 102-106 may be a mobile computing device including, but not limited to, the Apple® iPhone, the Palm Pre, the Samsung Rogue, the Blackberry Storm, and the Apple® iPod Touch®. Data storage typically includes network storage systems as shown with reference to FIG. 1 that include the devices 102-106. In this embodiment, the device 102 includes data 108 that has been encrypted using a first security key. As used herein, a security key is a key that is used in conjunction with an encryption algorithm in order to encrypt data, as one skilled in the art would readily appreciate. Thus, the data 108 has been encrypted using the first security key. As will be detailed below, in one embodiment, the first security key is hidden as data 110-114 stored on the devices 104 and 106. In an embodiment, the data 108-114 corresponds to security keys and QR codes, which are generated using a method shown with reference to FIGS. 2A and 2B.

FIGS. 2A and 2B illustrates a method for security key storage in accordance with an embodiment of the present disclosure. Here, a black and white QR code is being used. A QR code is a matrix symbol having an array of nominally square modules arranged in an overall square pattern. A QR code includes a unique finder pattern located at three corners of the square pattern, where the unique finder pattern is configured to assist in the location of its size, position, and inclination. Embodiments of the present disclosure use QR codes along with watermarking techniques, where a security key is stored on the QR code using watermarking techniques. Initially, a host QR image QR_{O} is generated in an operation 201. In an embodiment, a fake security key is used to generate the host QR image OR_{O}. A first security key that was used to encrypt data is then obtained in an operation 202. For example, during the operation 202, the first security key that was used to encrypt the data 108 is obtained and is then divided into N portions in an operation 204. As an example, the first security key may be divided into five separate portions in the operation 204. Thus, in this example, N equals five.

Once the first security key is divided into N portions, a second security key is obtained in an operation 206. The second security key is used to encrypt and then decrypt the portions of the first security key in conjunction with an encryption algorithm. In an embodiment, the encryption algorithm may be any encryption algorithm known to one skilled in the art. The second security key will be used in conjunction with an encryption algorithm to encrypt a portion of the first security key in order to create a first watermark in an operation 207. In the operation 207, a first portion of the first security key is encrypted using the second security key in conjunction with an encryption algorithm to create the first watermark.

After creation of the first watermark in the operation 207, the first watermark is embedded into the host QR image QR_{O} to create a first QR code host image QR₁ in an operation 208. In this embodiment, the first QR code is a black and white QR code, where the first QR code will be a host image for watermarking steps that will be used when subsequent portions of the first security key are encrypted and stored with the first QR code. Moreover, as will be discussed below, in further embodiments, a color image may be used as the host image. Returning to the example, in the operation 206, a second security key that will be used in conjunction with an encryption algorithm to encrypt the five portions of the first security key is obtained. A first portion of the five portions of the first security key is then encrypted with the second security key to create a first watermark in the operation 207. The first watermark is then embedded into the host QR code image in the operation 208 in order to create a first QR code host image QR₁.

After the first QR code host image QR₁ is generated in the operation 208, a next portion of the first security key is encrypted thereby creating a second watermark with the next portion of the first security key in an operation 210. In this operation, a next portion of the first security key is encrypted using the second security key in conjunction with an encryption algorithm in a manner similar to that described above with reference to the operation 207. Once the next portion of the first security key is encrypted, the next portion is embedded as a watermark to a transformation of the first QR code using any suitable watermarking technique in an operation 212. Stated differently, during the operation 212, the next portion of the first security key is embedded into a transformation of the first QR code thereby creating a second QR code host image QR₂ during the operation 212 using any well-known technique, such as that disclosed in P. H. W. Wong, O. C. Au, and Y. M. Yeung, “A novel blind multiple watermarking technique for images,” IEEE Trans. Circuits and Systems for Video Technology, vol. 13, no. 8, pp. 813-830, August 2003, which is hereby incorporated by reference. Turning back to the example, the second portion of the five portions of the first security key is encrypted with the second security key and then embedded into a transformation of the first QR code during the operations 210 and 212. Thus, during the operations 210 and 212, the first QR code host image QR₁ is transformed to the second QR code host image QR₂ with the encrypted second portion of the security key.

After the second QR code is generated in the operation 212, a determination is made if there are additional portions of the first security key in an operation 214. If there is a third portion of the first security key, the operations 210 and 212 are repeated. If there are no other portions of the first security key, for purposes of this disclosure, the QR code host image QR_{N} generated, where N equals the number of portions of the first security key in the operation 212 is the QR code host image QR_{N} and an operation 216 is performed.

In an embodiment of the present disclosure, when the operations 210 and 212 are repeated, a QR code host image QR_{N} having multiple layers is created. In other words, the QR code host image QR_{N} has multiple layers. In particular, returning to the example, as noted above, N equals five since the first security key has been divided into five portions. Therefore, a determination is made in the operation 214 that three additional portions exist for the first security key and the operations 210 and 212 will be repeated three more times for the third, fourth, and fifth portions of the first security key. In this embodiment, three additional QR codes will be created for the three additional portions of the first security key such that these three additional QR codes will successively be embedded into a transformation of a previous QR code thereby creating a QR code host image QR₅ during the operation 212. Thus, the encrypted third portion of the first security key will be embedded to a transformation of the second QR code host image QR₂ using any well-known watermarking technique thereby creating a third QR code host image QR₃. This will be repeated two additional times in order to create a fifth QR code host image QR₅, which in accordance with embodiments of the present disclosure, is called the QR code host image QR_{N}. It should be noted that the operations 210 and 212 will be repeated N number of times in order to create a QR code host image QR_{N}. Furthermore, since the QR code host image QR_{N} is embedded with a number of watermarks, the QR code host image QR_{N} has multi-layers or multi-dimensions. In an embodiment, the number of layers corresponds to the number N into which the first security key is divided. Thus, in the example, the first security code has five layers, or five dimensions. In the example, after the additional three portions of the first security key are embedded into previous QR codes as mentioned above, the last QR code generated in the operation 212 is the first security key QR code image and the operation 216 is performed.

In the operation 216, a determination is made regarding whether or not portions of the first security key are visible in the QR code image host image QR_{N}. For example, this determination may be made by using a standard QR decoder to detect the visibility of watermarks in the host image. For example, if the fake security key used to generate the host QR image QR_{O} may be obtained from the QR code image host image QR_{N}, in an embodiment, this is indicative of the watermarks being invisible. On the other hand, if the fake security key is used to generate the host QR image QR_{O} is not obtainable, in an embodiment, this is due to too much noise being created by watermarks in the QR code image host image QR_{N}. In other words, the noise is indicative of the watermarks and portions of the first security key being visible in the QR code image host image QR_{N}. If it is determined that a portion of the first security key is visible is in the QR code host image QR_{N}, then the number of N portions into which the first security key is divided is reduced in an operation 218 and the operations 204 through 216 are repeated. To further illustrate, if the first security key was divided into fifteen portions such that the number N equals fifteen and a determination is made in the operation 216 that a portion of the first security key is visible in the QR code host image QR_{N}, the number N may be reduced to ten in the operation 204 such that the first security key is divided into ten portions in the operation 204 and the operations 206-216 are repeated for the ten portions of the first security key.

If a determination is made in the operation 216 that portions of the first security key are not visible in the QR code host image QR_{N}, then operations 220 and 222 are performed. In these operations, the second security key and a map are encrypted by obtaining a third security key (operation 220) and using the third security key in conjunction with an encryption algorithm thereby forming a second security key QR code in the operation 222. In an embodiment of the present invention, the map corresponds to the constructions of the first security key and is used reassemble the first security key as described below. Once the second security key QR code is generated in the operation 222, an operation 224 is performed where the third security key, the QR code host image QR_{N}, and the second security key QR code are stored. Thus, in the embodiment of FIGS. 2A and 2B, three components are stored, the third security key, the QR code host image QR_{N}, and the second security key QR code. In one embodiment, all three components may be stored online, such as in the devices 102-106 where the three components may correspond to one of the data 108-114. In a further embodiment, a hardcopy of the QR code host image QR_{N} may be generated, such as printing out using any printing means, and physically stored offline with the owner of the data encrypted using the first security key. In another embodiment, a device performing the method 200, such as the device 102, may send the third security key, the QR code host image QR_{N}, and the second security key QR code to the devices 104 and 106 over a network, such as the cloud based operating system 100 for respective storage of the third security key, the QR code host image QR_{N}, and the second security key QR code on the devices 104 and 106.

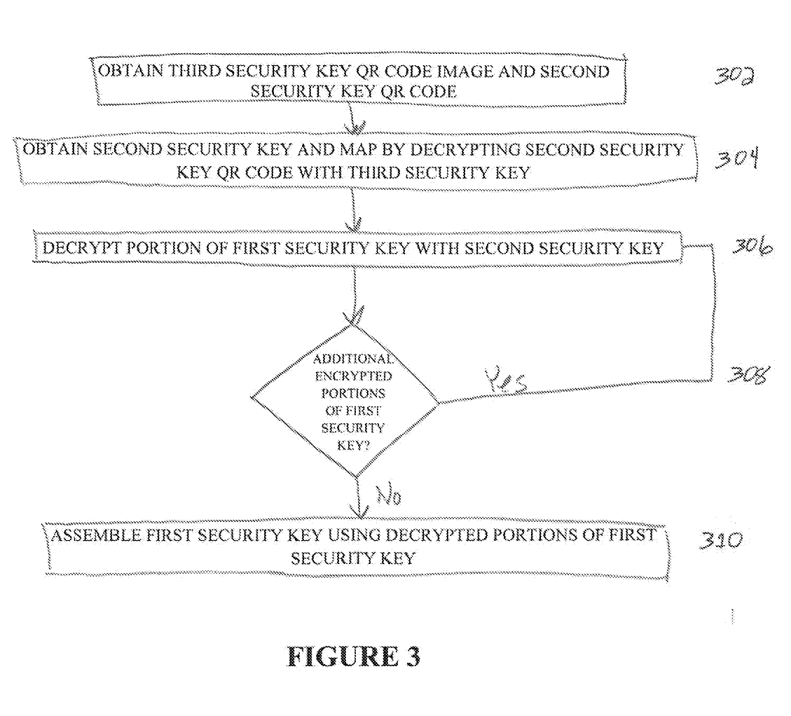

Turning to FIG. 3, shown is an embodiment of the present disclosure illustrating a method 300 of accessing the first security key stored using the method 200. In an operation 302, the third security key, the QR code image, and the second security key QR code are obtained. Then, in an operation 304, the second security key and the map are obtained by decrypting the second security key QR code using the third security key in conjunction with a decryption algorithm. In particular, during the operation 304, the owner provides the third security key in order to decrypt the second security key QR code. During the operation 304, the second security key QR code is scanned, read, and then the third security key is used in conjunction with the map and the encryption algorithm used to generate the second security key QR code, to decrypt the second security key QR code and obtain the second security key.

Once the second security key is obtained in the operation 304, a portion of the first security key is decrypted from the QR code host image QR_{N} in an operation 306. During the operation 306, the QR code host image QR_{N} is scanned, read, and then the second security key is used in conjunction with the encryption algorithm used to decrypt the first security key QR code image and obtain the first security key. If the QR code host image QR_{N} is stored offline, the owner provides the QR code host image QR_{N} for scanning and reading. If the QR code host image QR_{N} is stored online, then the QR code host image QR_{N} is obtained, scanned, and read. In an embodiment, the N portion of the first security key is decrypted since the QR code host image QR_{N} has N layers. To further illustrate, if the first security key has five portions and the QR code host image QR_{N} has five layers or five dimensions, the fifth portion is first decrypted in the operation 306. After a portion of the first security key is decrypted in the operation 306, a determination is made in an operation 308 if there are additional portions of the first security key. For example, if the first security key was divided into five portions and only the fifth portion was decrypted in the operation 306, the operation 306 is repeated four more times, where the fourth portion of the security key is decrypted followed by the third portion, the second portion, and finally the first portion. In other words, the operation 306 is repeated N times where the QR code host image QR_{N} is decrypted in reverse order of encryption. For example, QR code host image QR₅ is decrypted first, followed by QR code host image QR₄, etc.

Once a determination is made in the operation 308 that no additional portions of the first security key have not been decrypted, an operation 310 is performed where the first security key is assembled using the map and provided to the owner.

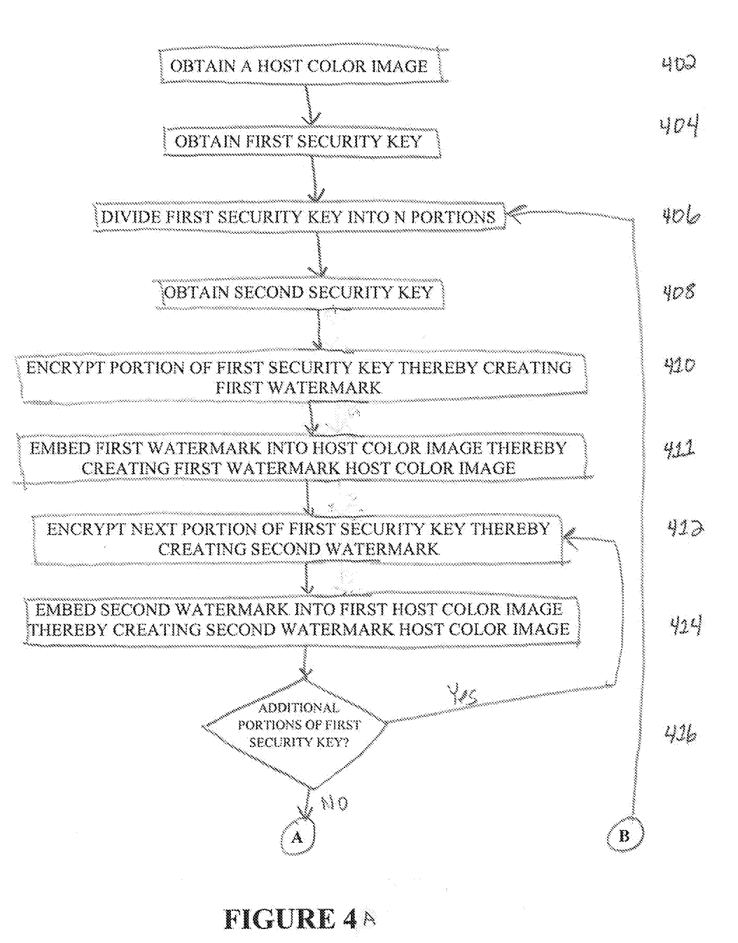

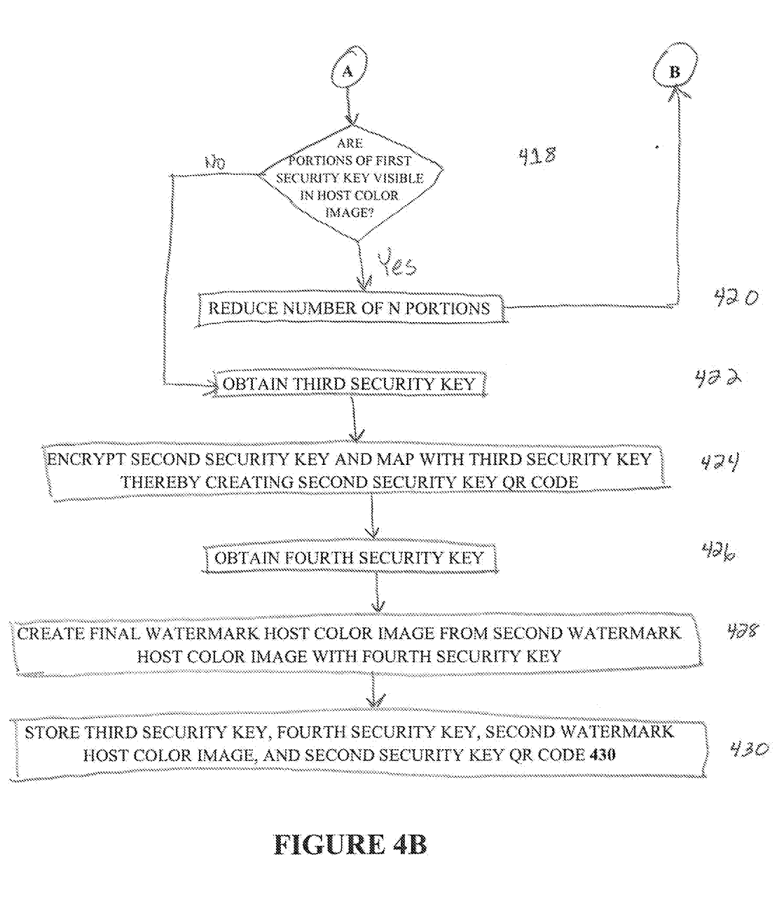

As mentioned above, the methods of FIGS. 2 and 3 are performed with respect to a black and white QR code. In further embodiments of the present disclosure, the first security key may be embedded into a host color image, as shown with reference to FIG. 4A. Initially, a host color image IMG_{O} is generated in an operation 402. In an embodiment, the host color image IMG_{O} is obtained where the host color image IMG_{O} may be any color image. Moreover, the host color image IMG_{O} will be used to store portions of the first security key as a watermark. After the host color image IMG_{O} is generated in the operation 402, the operations 404-408 are performed. The operations 404-408 are similar to the operations 202-206 as discussed above. Therefore, the reader is encouraged to refer to the discussion of the operations 202-206 for a further understanding of the operations 404-408.

Once the operation 408 is performed, an operation 410 is performed where the portion of the first security key is encrypted in order to create a first watermark. In an embodiment, a first portion of the first security key is encrypted using the second security key in conjunction with an encryption algorithm such that a first watermark is created in the operation 410. For example, a first security key is divided into five portions in the operations 404 and 406. In the operation 410, the first portion is encrypted using the second security key in conjunction with an encryption algorithm in order to create a first watermark using any well-known watermarking technique, such as the technique referenced above in the operation 212. It should be noted that all of the watermarks that are created in accordance with embodiments of the present invention may be done using any well-known watermarking technique.

Once the first watermark is created in the operation 410, the first watermark is embedded into the host color image to create a first watermark host color image IMG₁ in an operation 411. The first watermark is embedded into the host color image using any well-known watermarking technique, such as the technique referenced above in the operation 212.

After the operation 411 is performed, an operation 412 is performed, where a next portion of the first security key is encrypted in order to create a second watermark. The operation 412 is similar to the operation 210. Accordingly, the reader is encouraged to refer to the discussion of the operation 210 for a further understanding of the operation 412. Turning back to the example, in the operation 412, a second portion of the first security key is encrypted using the second security key in conjunction with an encryption algorithm thereby creating a second watermark.

After the next portion of the first security key is encrypted in the operation 412, an operation 414 is performed where the second watermark is embedded into the first watermark host image IMG₁ using any well-known watermarking technique in order to create a second watermark host color image IMG₂, as mentioned above. Turning back to the example, the second watermark is embedded into the first watermark host color image IMG₁ in order to create a second watermark host image IMG₂ using the watermarking techniques described above.

Once the second watermark host color image IMG₂ is created, an operation 416 is performed, where a determination is made if there are additional portions of the first security key. If there are additional portions of the first security key, the operations 412 and 414 are repeated. If there are no other portions of the first security key, an operation 418 is performed.

In an embodiment of the present disclosure, when the operations 412 and 414 are repeated, a watermark having multiple layers or multiple dimensions is created. In particular, returning to the example, as noted above, N equals five since the first security key has been divided into five portions. Therefore, a determination is made in the operation 416 that three additional portions exist for the first security key and the operations 412 and 414 will be repeated three more times for the third, fourth, and fifth portions of the first security key. In this embodiment, three additional watermarks will be created for the three additional portions of the first security key such that these three additional watermarks will successively be embedded into a prior watermark during the operation 414. Thus, a watermark for the encrypted third portion of the first security key will be embedded into the second watermark host color image IMG₂ to create a third watermark host color image IMG₃ using any well-known watermarking technique thereby creating a third watermark. This process will be repeated two additional times in order to create a fifth watermark host color image IMG₅, which in accordance with embodiments of the present disclosure is the watermark host image IMG_{N}. It should be noted that the operation will be repeated N number of times in order to create N watermark host color image IMG_{N}, which will be the first security key watermark host image. Furthermore, since the first security key watermark host image is embedded with a number of watermarks, the first security key watermark host image has multiple layers or multiple dimensions. In an embodiment, the number of layers or dimensions corresponds to the number N into which the first security key is divided. Thus, in the example, the first security key has five layers, or five dimensions. In the example, after the additional three portions of the first security key are sequentially embedded into the host color image to create the fifth watermark host color image IMG₅, or the first security key watermark host image, an operation 418 is performed.

In the operation 418, a determination is made regarding whether or not portions of the first security key are visible in the first security key watermark in the host color image. If it is determined that a portion of the first security key is visible is in the watermark of the host color image, then the number of N portions into which the first security key is divided is reduced in an operation 420 and the operations 406-418 are repeated. To further illustrate, if the first security key was divided into fifteen portions such that the number N equals fifteen and a determination is made in the operation 418 that a portion of the first security key is visible in the watermark of the host color image, the number N may be reduced to ten in the operation 406 such that the first security key is divided into ten portions in the operation 406 and the operations 408-418 are repeated for the ten portions of the first security key.

If a determination is made in the operation 418 that the first security key watermark is not visible in the host color image, operations 422 and 424 are performed. In these operations, the second security key and map similar to the map described above with reference to FIGS. 2 and 3 are encrypted by obtaining a third security key (operation 422) and using the third security key in conjunction with an encryption algorithm thereby forming a second security key QR code in the operation 424. Once the second security key QR code is generated in the operation 424, an operation 426 is performed where a fourth security key is obtained in order to create a final watermark host color image IMG_{F} from the second watermark host color image IMG₂ using any well known watermarking technique in an operation 428. Turning back to the example, in the operation 418, a determination is made that portions of the first security key are not visible in the watermark in the host color image. Thus, the operations 424-428 are performed where the second security key and a map which may be used to reassemble the first security key are encrypted using a third security key in order to generate a second security key QR code and a final watermark host color image IMG_{F} is created from the second watermark host color image using the fourth security key.

Upon completion of the operation 428, an operation 430 is performed where the third and fourth security keys, the second security key QR code, and the host color image are stored. In this embodiment, each of these components may be stored online at the devices 102-106 where the four components may correspond to the data 108-114. In another embodiment, a device performing the method in FIGS. 4A and 4B, such as the device 102, may send the third and fourth security keys, the second security key QR code, and the host color image to the devices 104 and 106 over a network, such as the cloud based operating system 100 for respective storage of the third and fourth security keys, the second security key QR code, and the host color image on the devices 104 and 106.

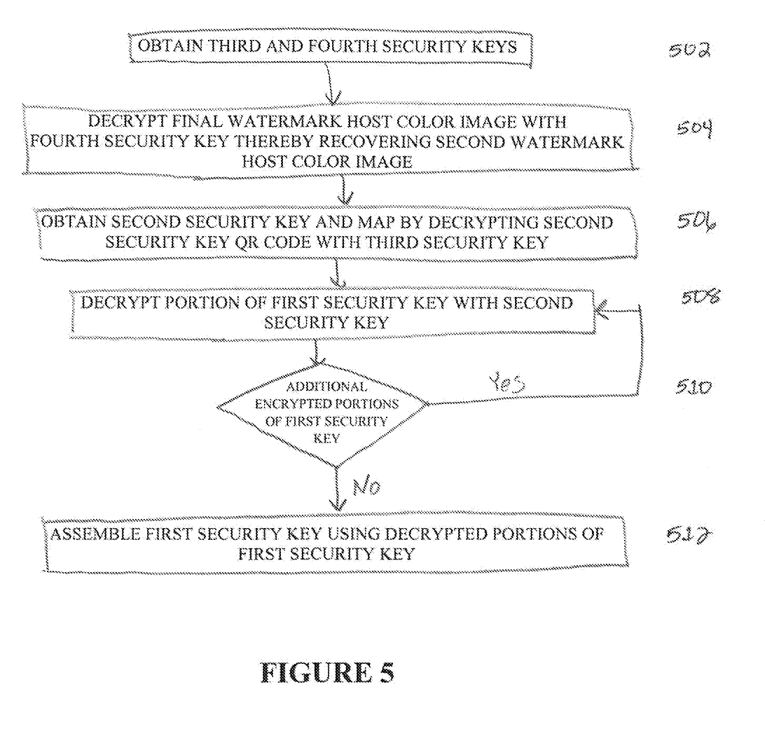

In order to retrieve the first security key embedded in the host color image in accordance with the method of FIGS. 4A and 4B, a method shown with reference to FIG. 5 is performed. In an operation 502, the third and fourth security keys are retrieved from storage. Then, in an operation 504, the final watermark host color image IMG_{F} is decrypted with the fourth security key in conjunction with the algorithm used to embed the second watermark thereby recovering the second watermark host color image IMG₂. Once the second watermark host color image IMG₂ is recovered, the second security key QR code is obtained, scanned, and then decrypted with the third security key in conjunction with the encryption algorithm used to encrypt the second security key QR code in an operation 506. When the second security key QR code is decrypted, the second security key and the map are obtained. For example, the third and fourth security keys are stored as the data 112 and 114 at the device 104. Thus, in the operation 502, the third and fourth security keys are obtained from the device 104 and the final watermark image IMG_{F} is decrypted using the fourth security key in the operation 504. Afterwards, the second security key is obtained by scanning and then decrypting the second security key QR code with the third security key in the operation 506 in this example.

Returning to FIG. 5 and the method shown therein, after the second security key is obtained in the operation 506, the operation 508 is performed, where a portion of the first security key is decrypted from the watermark embedded into the second watermark host color image IMG₂ with the second security key. During the operation 508, the second security key is used in conjunction with the encryption algorithm used to generate the watermark, to decrypt the watermark and obtain the first security key. In an embodiment, the N portion of the first security key is decrypted since the watermark has N layers. To further illustrate, if the first security key has five portions and the watermark has five layers or five dimensions, the fifth portion is first decrypted in the operation 508. After a portion of the first security key is decrypted in the operation 508, a determination is made in an operation 510 if there are additional portions of the first security key. For example, if the first security key was divided into five portions and only the fifth portion was decrypted in the operation 508, the operation 508 is repeated four more times, where the fourth portion of the security key is decrypted followed by the third portion, the second portion, and finally the first portion. In other words, the operation 508 is repeated N times.

Once a determination is made in the operation 510 that no additional portions of the first security key have been decrypted, an operation 512 is performed where the first security key is assembled and provided to the owner using the map.

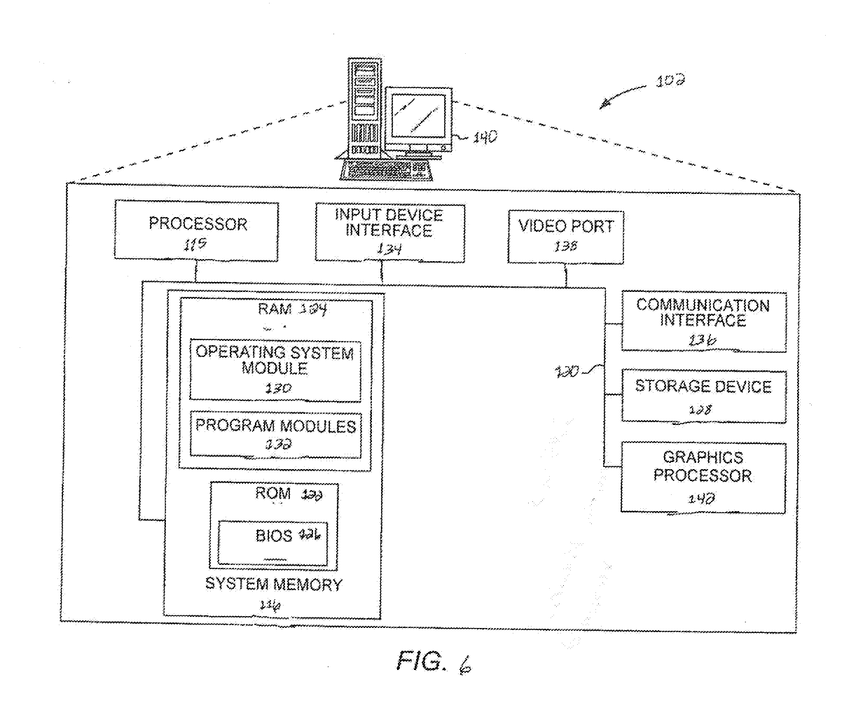

FIG. 6 is a block diagram of the device 102 according to one embodiment of the present disclosure. It should be noted that while this discussion focuses on the device 102, this description is equally applicable to the devices 104 and 106, where the devices 104 and 106 include identical components having identical functionality. The device 102 may comprise any computing or processing device capable of executing software instructions to implement the functionality described herein, such as, by way of non-limiting example, a work station, a desktop or laptop computer, a tablet computer, or the like. The device 102 includes a processor 115, a system memory 116, and a system bus 120. The system bus 120 provides an interface for system components including, but not limited to, the system memory 116 and the processor 115. The processor 115 may be any commercially available or proprietary processor. Dual microprocessors and other multi-processor architectures may also be employed as the processor 115.

The system bus 120 may be any of several types of bus structures that may further interconnect to a memory bus (with or without a memory controller), a peripheral bus, and/or a local bus using any of a variety of commercially available bus architectures. The system memory 116 may include non-volatile memory 122 (e.g., read only memory (ROM), erasable programmable read only memory (EPROM), electrically erasable programmable read only memory (EEPROM), etc.) and/or volatile memory 124 (e.g., random access memory (RAM)). A basic input/output system (BIOS) 126 may be stored in the non-volatile memory 122, and can include the basic routines that help to transfer information between elements within the device 102. The volatile memory 124 may also include a high-speed RAM, such as static RAM, for caching data.

The device 102 may further include the computer-readable storage device 128, which may comprise, by way of non-limiting example, an internal hard disk drive (HDD) (for example, an enhanced integrated drive electronics (EIDE) HDD or serial advanced technology attachment (SATA) HDD), a flash memory, or the like. The computer-readable storage device 128 and other drives, sometimes referred to as computer-readable or computer-usable media, provide non-volatile storage of data, data structures, computer-executable instructions, and the like. Although for purposes of illustration the description of the computer-readable storage device 128 above refers to a HDD, it should be appreciated by those skilled in the art that other types of media which are readable by a computer, such as zip disks, magnetic cassettes, flash memory cards, cartridges, a Universal Serial Bus memory stick, and the like, may also be used in the operating environment, and further, that any such media may contain computer-executable instructions for performing novel functionality as disclosed herein.

A number of modules can be stored in the computer-readable storage device 128 and in the volatile memory 124, including an operating system module 130 and one or more program modules 132, which may implement the functionality described herein in whole or in part. It is to be appreciated that the embodiments can be implemented with various commercially available operating system modules 130 or combinations of operating system modules 130.

All or a portion of the embodiments may be implemented as a computer program product stored on a non-transitory computer-usable or computer-readable storage medium, such as the computer-readable storage device 128, which may include complex programming instructions, such as complex computer-readable program code, configured to cause the processor 115 to carry out the functionality described herein. Thus, the computer-readable program code can comprise software instructions for implementing the functionality of the embodiments described herein when executed on the processor 115. The processor 115, in conjunction with the program modules 132 in the volatile memory 124, may serve as a control system for the device 102 that is configured to or adapted to implement the functionality described herein. Moreover, all or portions of the embodiments of the present disclosure may by implemented across various network devices, where data is transferred between first and second devices over a network.

A user may be able to enter commands and information into the device 102 through one or more input devices, such as, for example, a keyboard (not illustrated), a pointing device such as a mouse (not illustrated), a touch-sensitive surface (not illustrated), or the like. Other input devices may include a microphone, an infrared (IR) remote control, a joystick, a game pad, a stylus pen, or the like. These and other input devices may be connected to the processor 115 through an input device interface 134 that is coupled to the system bus 120, but can be connected by other interfaces such as a parallel port, an Institute of Electrical and Electronic Engineers (IEEE) 1394 serial port, a Universal Serial Bus (USB) port, an IR interface, and the like.

The device 102 may also include a communication interface 136 suitable for communicating with a network. The device 102 may also include a video port 138 that drives the display device 140. The video port 138 may receive imagery, such as water surface imagery, from a graphics processor 142. The display device 140 may be separate from the device 102, or may be integrated with the device 102. Non-limiting examples of the display device 140 include an LCD or plasma monitor, a projector, or a head-mounted display.

Those skilled in the art will recognize improvements and modifications to the preferred embodiments of the present disclosure. All such improvements and modifications are considered within the scope of the concepts disclosed herein and the claims that follow.

What is claimed is:

1. A method for storing a security key, comprising:
(A) obtaining a first security key;
(B) dividing the first security key into N portions;
(C) obtaining a second security key;
(D) encrypting a portion of the first security key using the second security key thereby creating first watermark;
(E) embedding the first watermark into a host QR code image QR_{O} thereby creating a first QR code host image QR₁ ;(F) encrypting a next portion of the first security key using the second security key thereby creating a second watermark;
(G) embedding the second watermark into the first QR code host image QR₁ thereby creating a QR code host image QR_{N} such that the QR code host image QR_{N} includes the second watermark with the first watermark embedded into the first watermark;
(H) determining if there are additional portions of the first security key;
(I) repeating operations (E)-(G) if there are additional portions of the first security key;
(J) obtaining a third security key if there are no additional portions of the first security key;
(K) encrypting the second security key using the third security key thereby creating a second QR code; and
(L) remotely storing the third security key, the QR code host image QR_{N}, and the second QR code by transmitting the third security key, the QR code host image QR_{N}, and the second QR code from a first device to a second device.

2. The method of claim 1, wherein the method further comprises:
(M) obtaining the third security key, the QR code host image QR_{N}, and the second QR code from remote storage;
(N) decrypting the second QR code using the third security key thereby obtaining the second security key;
(O) decrypting the next portion of the first security key in the QR code host image QR_{N} using the second security key;
(P) determining if there are additional encrypted portions of the first security key;
(Q) repeating the operations (O) and (P) if there are additional encrypted portions of the first security key; and
(R) assembling the first security key with the decrypted next portion of the first security key if there are no additional encrypted portions of the first security key.

3. The method of claim 2, wherein the QR code host image QR_{N} has N number of layers, where the N number of layers of the QR code host image QR_{N} is equal to the N portions of the first security key.

4. The method of claim 2, wherein the method further comprises:
(S) determining if the first security key is visible in the QR code host image QR_{N};
(T) dividing the first security key into M portions, wherein M<N; and
(U) repeating the operations (D)-(I).

5. The method of claim 1, wherein the method further comprises:
(M) determining if the first security key is visible in the QR code host image QR_{N};
(N) dividing the first security key into M portions, wherein M<N; and
(0) repeating the operations (D)-(I).

6. The method of claim 1, wherein the second watermark is embedded to a transformation of the first QR code host image QR₁ thereby creating the QR code host image QR_{N}.

7. The method of claim 6, wherein the QR code host image QR_{N} has N number of layers, where the N number of layers of the QR code host image QR_{N} is equal to the N portions of the first security key.

8. The method of claim 1, wherein the encrypted next portion of the first security key that is encrypted into the first QR code host image QR₁ is encrypted using a watermarking technique.

9. A method for storing a security key, the method comprising:
(A) generating a watermark host color image IMG_{O};
(B) obtaining a first security key;
(C) dividing the first security key into N portions;
(D) obtaining a second security key;
(E) encrypting a portion of the first security key using the second security key thereby creating a first watermark;
(F) embedding the first watermark into the watermark host color image IMG_{O} thereby creating a first watermark host color image IMG₁;
(G) encrypting a next portion of the first security key using the second security key thereby creating a second watermark;
(H) embedding the second watermark into the first watermark host color image IMG₁ thereby creating watermark host color image IMG_{N};
(I) determining if there are additional portions of the first security key;
(J) repeating operations (G)-(I) if there are additional portions of the first security key;
(K) obtaining a third security key if there are no additional portions of the first security key;
(L) encrypting the second security key using the third security key thereby creating a QR code;
(M) obtaining a fourth security key;
(N) creating a final watermark host color image IMG_{F} from the watermark host color image IMG_{N}; and
(O) remotely storing the third security key, the fourth security key, the QR code, and the final watermark host color image IMG_{F}.

10. The method of claim 9, wherein the method further comprises:
(P) obtaining the third security key and the fourth security key from remote storage;
(Q) decrypting the final watermark host color image IMG_{F} with the fourth security key, thereby recovering the watermark host color image IMG_{N};
(R) decrypting the QR code using the third security key, thereby obtaining the second security key;
(S) decrypting the next portion of the first security key using the second security key;
(T) determining if there are additional encrypted portions of the first security key;
(U) repeating the operations (S) and (T) if there are additional encrypted portions of the first security key; and
(V) assembling the first security key with the decrypted next portion of the first security key if there are no additional encrypted portions of the first security key.

11. The method of claim 10, wherein the method further comprises:
(W) determining if the first security key is visible in the host image;
(X) dividing the first security key into M portions, wherein M<N; and
(Y) repeating the operations (D)-(J).

12. The method of claim 9, wherein the method further comprises:
(P) determining if the first security key is visible in the host image;
(Q) dividing the first security key into M portions, wherein M<N; and
(R) repeating the operations (D)-(J).

13. The method of claim 9, wherein the first watermark has N number of layers, where the N number of layers of the first watermark is equal to the N portions of the first security key.

14. The method of 9, wherein the host image is a color image.
